(19) United States
(12) Patent Application Publication
(10) Pub. No.: US 2003/0142948 A1
(43) Pub. Date: Jul. 31, 2003

(54) Fiber optic signal transfer method

(76) Inventor: Larry D. Lucas, Huntsville, AL (US)

Correspondence Address: Legal Office, (AMSAM-L-G-I, Mr. Fred M. Bush), US Army Aviation and Missile Command, Redstone Arsenal, AL, 35898-5000, US

(21) Appl. No.: 10/058,876

(22) Filed: Jan. 28, 2002

(51) Int. Cl. G02B 6/00

(52) U.S. Cl. 385/147

(57) ABSTRACT

The fiber optics signal transfer method employs a single composite drum system and a shaft. Power is delivered to the shaft for rotating the composite drum to the desired pay out speeds. Optical fiber is wound around the single composite drum as it is peeled from a bobbin located several feet away. The shaft, which drives the composite drum, is provided with a hole that is machined in the center of the shaft to approximately ½ of the shaft length. A fiber optic guide tube directs the fiber optic to the center of the shaft and out the exit end of the shaft. At the exit end of the shaft the signal exits the fiber, travels a distance in the air, and the signal through the fiber is subsequently picked up by a stationary photodiode detector. The method includes directing the optical fiber through a winding tension controller, which maintains the tension in the fiber. This winding tension controller controls tension of the fiber through a set of three pulleys, a lower pulley, and two upper pulleys. The winding tension functions by movement of the lower pulley in an up and down mode to control proper tension in the fiber as the fiber from a bobbin is wound on one of the upper pulleys, thence around the lower pulley, and thence around the second upper pulleys which subsequently routes the optical fiber for winding on the composite drum. Alignment of the optical fiber being wound on the composite drum is controlled by a level winding system that also supports the winding tension controller.

### DEDICATORY CLAUSE

The invention described herein may be manufactured, used, and licensed by or for the Government for governmental purposes without the payment to me of any royalties theron.

### BACKGROUND OF THE INVENTION

An optical fiber pay out test bed is to simulate optical fiber pay out from a missile. The prior testing performed by MICOM (The U.S. Army Missile Command) was to physically demonstrate signal transfer, adhesive technology, and other pay out performance parameters. A pinch wheel pay out machine developed by Optelicon Company, Inc has been used in extensive testing at lower pay out speeds. This pinch wheel pay out machine has limited capability in that it can only achieve pay out at speeds of Mach 0.5 or less, and cannot maintain an optical signal during the pay out event. For demonstration of pay out events greater than Mach 0.5, tests are performed utilizing an F-16 jet fighter aircraft as the pay out platform. The tests with the F-16 platform are very expensive and difficult to schedule so that only a limited amount of tests are performed at the higher speeds.

To address the limited capability and to advance pay out technology, an ongoing effort has been established to develop a new pay out test bed. Several concepts were evaluated to include a pinch wheel, spinning reel, pneumatic nozzle, differential drum, and pneumatic shoe designs. After evaluation, two concepts were recommended as having the least development risk, the spinning reel and differential drum. After further evaluation, it was recommended that the differential drum concept be developed. A mechanical evaluation of the differential drum concept was performed to estimate component sizes and power requirements for pay out events at Mach 1.0. The evaluation indicated two major disadvantages with the differential drum concept. The system demands very large power requirements on the order of 400 Hp to achieve the desired pay out speeds, and the system require two pay out bobbins to maintain a signal throughout. The power requirements alone challenge the feasibility of the differential drum concept for a new optical fiber pay out test bed.

An object of this invention is to provide a method for a fiber optic signal transfer system that maintains a signal transfer at a pay out speeds of at least Mach 1.0.

Another object of this invention is to provide a pay out test bed employing a composite drum system wherein the power requirements are reduced from 400 Hp for a differential drum system to approximately 138 Hp for the composite drum system.

### SUMMARY OF THE INVENTION

The composite drum pay out system of this invention employs a single drum and shaft. The composite drum is mounted on specially designed shaft that is provided with a hole machined in the center of the shaft to approximately ½ of the shaft length. The shaft is threaded at one end for fixation of a fiber optic chuck. In a test procedure the shaft is placed in the chuck of a common lathe to rotate the single drum at the desired speed. The test procedure for filling the drum comprises routing the fiber from a pay out bobbin through a winding tension controller, around a winding pulley, and onto a spool, which represents the composite drum. Next, the end of the fiber is routed through the center of the shaft, and into the fiber chuck. A LASER source is provided at the bobbin end of the fiber. A LASER signal travels through the fiber on the bobbin and spool, exits the end of the fiber, travels through the air, and is picked up by an optical lens and photodiode receiver. The photodiode converts the LASER signal to an analogue output in mV. The receiver is mounted on adjustable plates in three perpendicular planes. The adjustable plates allow the receiver to be precisely aligned with the axis of the fiber chuck.

### BRIEF DESCRIPTION OF THE DRAWINGS

FIG. 1 of the drawing depicts a prior art method employing differential drums, which required approximately 400 Hp to operate the drums since this method required a small drum to maintain signal transfer through the fiber wound on a large drum from a test bobbin. The pay out speed of this method is limited to about 0.5 Mach or less.

FIG. 2 of the drawing depicts the composite drum pay out system, which employs a single drum, and shaft, which reduces the power requirement from about 400 Hp to about 138 Hp while maintaining signal transfer at pay out speeds of at least Mach 1.0.

FIG. 3 depicts the composite drum in combination with a winding tension controller and a level winding system for the optical fiber being wound on the composite drum.

FIG. 4 depicts an expanded view of the winding tension controller depicted in FIG. 3.

### DESCRIPTION OF THE PREFERRED EMBODIMENT

The composite drum pay out system of this invention requires a composite drum and shaft weighing 25 pounds and 5 pounds, respectively; whereas, the differential drum system of the prior art requires two drums, a large drum and a small drum, to perform a pay out event. The large drum performs the actual pay out at the desired speeds up to about 0.5 Mach, and the small drum provides the link to maintain signal throughout. The prior art system requires approximately 400 Hp to achieve the pay out speed in 10 seconds (with a 25 inch diameter drum). The weights of the large drum, small drum, and shaft are approximately 99, 11, and 82 pounds.

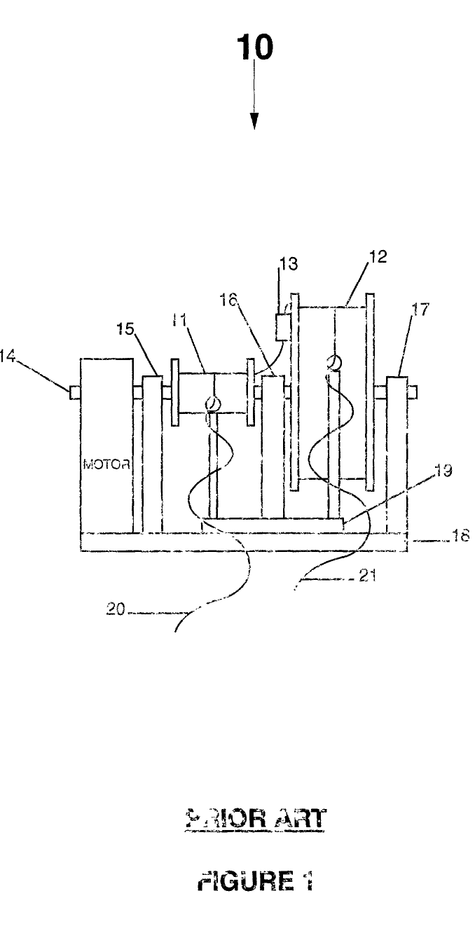

In further reference to the Figures of the drawing, FIG. 1 depicts the prior art differential drum concept 10, which comprises a small drum 11, a large drum 12, and a connector 13 through which the optical fiber is routed between the small drum and the large drum. A motor with a rotating shaft 14 supplies the power for turning the drums for a pay out speeds up to about 0.5 Mach. The shaft which is connected to the drums for rotational speed thereof is supported by bearings 15, 16, and 17. The differential drum concept requires two drums to perform a pay out event. The large drum performs the actual pay out at the desired speed, and the small drum provides the link to maintain signal throughout the optical fiber 20 from the optical link bobbin (not shown), and optical fiber 21 from the test bobbin (not shown). The drums are provided with a level wind system 19 for maintaining proper alignment between the drums and to maintain level alignment of the optical fibers. Base 18 provides support means for the motor and bearings 15, 16, and 17 as depicted in FIG. 1.

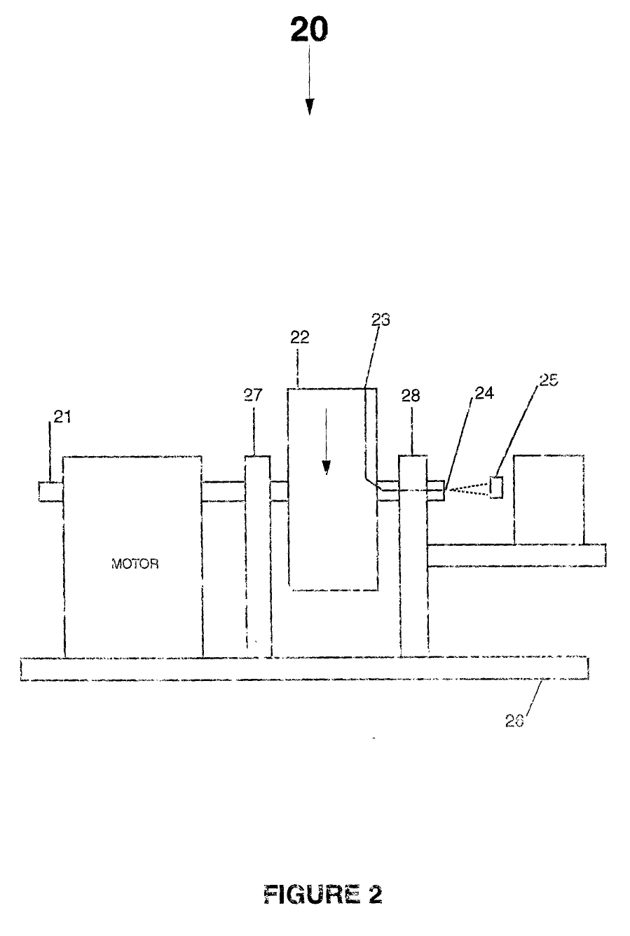

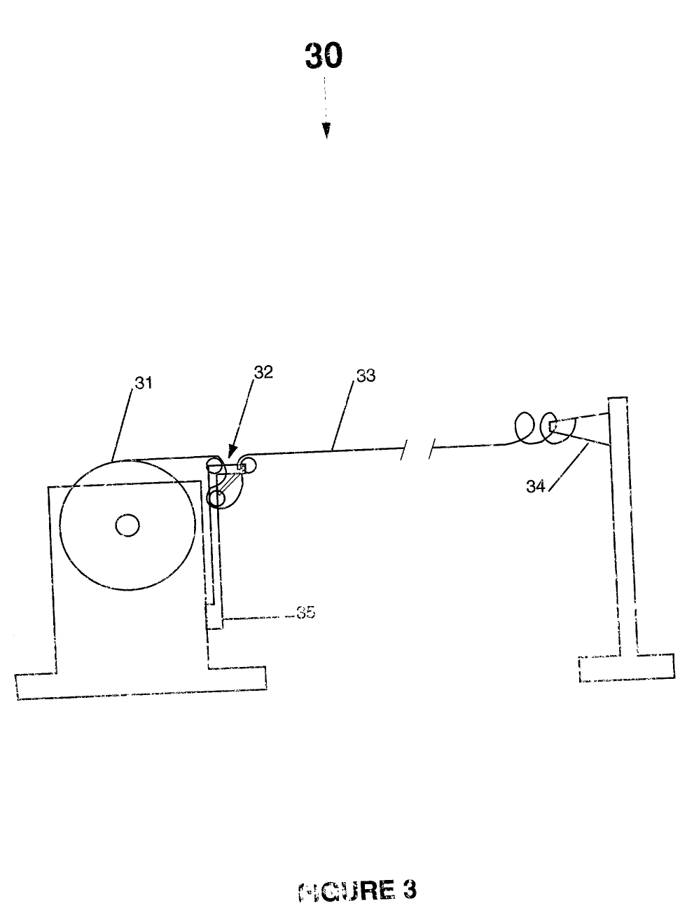

FIG. 2 depicts a composite drum system 20 employing a single drum and shaft. A base 26 provides support means for the motor and shaft bearings 27 and 28, which corresponds to base 18 and shaft bearings 15 and 17 as depicted in FIG. 1. Power is delivered to the shaft rotating the drum 22 to the desired pay out speeds. Optical fiber is wound around the drum as it is peeled from a bobbin located several feet away, as shown in FIG. 3. This composite drum system comprises a shaft 21, which drives the composite drum 22. A hole is machined in the center of the shaft to approximately ½ of the shaft length. A fiber optic guide tube 23 directs the fiber optic to the center of the shaft and out the exit end 24 of the shaft. At the exit end of the shaft the signal exits the fiber, travels a distance in the air, and is picked up by a photodiode detector 25 (stationary) as illustrated in FIG. 2.

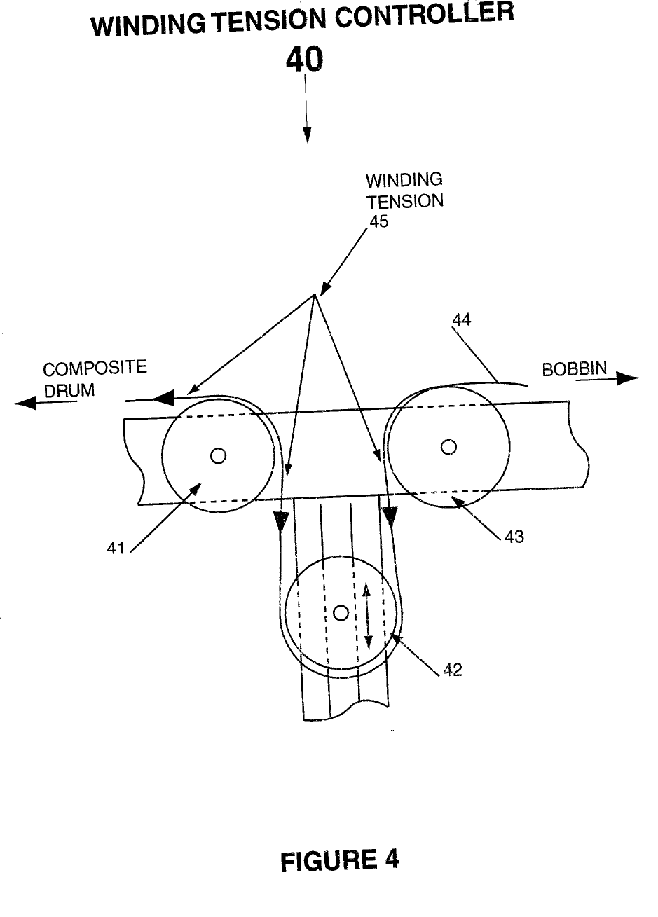

FIG. 3 illustrates a composite drum pay out event 30 wherein a composite drum 31 is shown receiving an optical fiber 33, which is received from a bobbin 34. The optical fiber is transferred through the winding tension controller 32, which is depicted in greater detail in FIG. 4. The winding tension controller 32 is supported by a level winding system 35, which maintains level alignment of the optical fiber on the drum.

FIG. 4 depicts an expanded view of the winding tension controller 40 to maintain tension in the fiber. Optical fiber 44 is wound around pulley 43 on the bobbin (not shown) side of the system. The friction in this pulley is controlled to maintain the tension in the fiber. The lower pulley 42 is used as a finer controller to maintain the tension. Movement of the lower pulley up or down controls the winding tension 45 of fiber to maintain proper tension in the fiber as the fiber is wound on pulley 41. The optical fiber is subsequently routed for winding on a composite drum (not shown) where a level winding system 35 controls level of the optical fiber.

The reduced weight of the composite drum pay out system greatly reduce the inertia of the system and thus, greatly reduce the power requirements of the system as compared to the differential drum system. Operation of the composite drum system requires 138 Hp as compared to 400 Hp for operation of the differential drum system.

The composite drum can be of three types, i.e. composite drum and spokes, composite drum with disks, and monolithic composite drum. The composite drum and spoke design consists of the drum, and three rims. Each rim has a hub and 30 spokes. A single mold is designed to hand lay up all of the parts from the rim, simultaneously. The spokes are fabricated with an unidirectional cloth (S-glass). The hub and other parts of the rim are fabricated with a fiberglass woven perform (S-glass). The hub requires fabrication around a metal sleeve in order to attach the spoked rim to the shaft. The rims are 4 inches apart, located at each end and at the middle of the drum.

A graphite drum approximately 0.15 inches thick is filament wound over the fiberglass rims. Two mandrels, which are cast separately using either sand, plaster, or foam, are positioned between the spoked rims during winding preparation. The mandrels provide a filament-winding surface between the spoked rims. Fiberglass tape is wrapped at each end of the drum before curing to form a boss that prevents the fiber from sliding off the ends of the drum. After curing, the mandrels are washed out with a solvent.

The graphite filament winding for the drum has hoop strength of 288,200 psi. Preliminary analysis indicates that the maximum radial deflection in the drum is 0.0005 inches, rotating at 10,241 rpm. The approximate weight of the concept is 20 lbs.

The composite drum and disk concept is similar to the spoke concept except that the rims are solid composite. The rims or disks are fabricated by hand lay up utilizing an S-glass preform. The approximate weight of this system is 25 lbs.

The monolithic composite drum concept is filament wound with the graphite IM-7/epoxy. The wall thickness of the drum is 0.5 inches eliminating the need for support in the center of the drum. The drum has aluminum pole pieces wound into the ends. Each pole piece would accommodate a threaded extension also eliminating the need for a shaft through the center of the drum. Like the spoke and disk concept, a boss is fabricated to prevent the fiber from slipping off the ends of the drum. This concept weighs approximately 40 lbs.

The monolithic composite drum concept is filament wound with graphite IM-7/epoxy. The wall thickness of the drum is 0.5 inches eliminating need for support in the center of the drum. The drum has two aluminum pole pieces wound into the ends. Each pole piece would accommodate a threaded extension also eliminating the need for a shaft through the center of the drum. Like the spoke and disk concept, a boss is fabricated to prevent the fiber from slipping off the ends of the drum. This concept weighs approximately 40 lbs.

A comparison of the different drum concepts are set forth in Table 1 below.

TABLE 1

| CONCEPT | DISK | SPOKE | MONOLITHIC |
|---|---|---|---|
| DIFFICULTY | challenge to | challenge to | easy to |
| | fabricate | fabricate | fabricate |
| FABRICATION | filament wound | filament wound | filament wound |
| PROCESS | and hand lay up | and hand lay up | |
| SYSTEM | 25 | 20 | 40 |
| WEIGHT (lbs) | | | |
| FABRICATION | 2 | 3 | 1 |
| COSTS* | | | |

*1 represents the least fabrication costs

Static and dynamic tests were performed to demonstrate the signal transfer method. A 250 μM diameter fiber was used for these tests. The LASER source, a Photodyne model 2230XR, transmitted a 1300 Nm wavelength signal through the fiber. The receiver (PD7035, Mitsubishi Electric Corporation) was aligned directly to an output lead from the source and measured to be 354.2 mV. The air gap between the end of the lead and receiver was approximately ¾ inches. A static test was performed by aligning he receiver with the fiber chuck and measuring signal losses with the same air gap. Dynamic tests were performed by rotating the spool and observing the receiver output. It was observed that there was a wobble in the fiber chuck so that the receiver was aligned with the axis at the center of the wobble. The same air gap was maintained and output voltages were observed. Table 2 below depicts Signal Transfer Test Results.

The signal through the optical fiber can be achieved by Radio Frequency (RF) or Infrared (IR) and which can be subsequently transferred to a remote receiver. The LASER signal and measurement of the output as described above is the preferred embodiment for signal transfer and measurement. This preferred embodiment is readily adaptable to a large scale testing of a simulated pay out event.

Table 2 below depicts Signal Transfer Test Results.

TABLE 2

| | Measured Output | Signal Loss |
|---|---|---|
| Test | (Mv) | (%) |
| LASER SOURCE | 354.2 | 0 |
| Static | 322.0 | 9 |
| Dynamic | 310.6-308.3 | 12-13 |

Test results indicate that the signal losses between the LASER source and the end of the fiber at the fiber optic chuck was approximately 0 percent. The dynamic tests indicate losses of 12 to 13 percent. Evaluations of the signal losses indicate that the the static signal losses of about 9 percent were indicative of the normal losses associated with splices and bends in the fiber. It is also concluded that losses of 12 to 13 percent are acceptable losses signal transfer tests during a pay out test event.

Further review of the test results indicate that the composite drum with spokes and composite drum with disks had the best lightweight properties; however, these composite drums are harder to fabricate and thus cost more than the monolithic composite drum. Based on the importance of using a lightweight drum, the composite drum with disks is the preferred composite drum for a pay out test bed.

I claim:

1. A fiber optic signal transfer system for an optical fiber pay out test bed comprising:
(i) providing a composite drum system employing a single composite drum and a rotatable shaft having shaft bearings;
(ii) a rotatable shaft having shaft bearings connected to a motor and said composite drum, said rotatable shaft provided with a opening that is machined in said rotatable shaft, said opening extending approximately ½ of the rotatable shaft length extending from said composite drum;
(iii) a motor for rotating said composite drum to a desired pay out speed;
(iv) a base for said composite drum system, said base providing support means for said motor for rotating said composite drum and said rotatable shaft having shaft bearings;
(v) an optical fiber wound around said composite drum as said optical fiber that is supplied from a bobbin, said optical fiber having capability for transmitting a LASER signal through out said optical fiber;
(vi) a fiber optic guide tube positioned perpendicular to the side of said composite drum, said fiber optic guide tube serving to route said optical fiber from said composite drum through said opening in said rotatable shaft thence through the center of said rotatable shaft to the end of said rotatable shaft where a signal exiting said optical fiber travels a predetermined distance in air, and is subsequently picked up by a photodiode detector; and,
(vii) a photodiode detector which includes an objective microscope lens for focusing said LASER signal to said photodiode detector which converts said LASER signal to an analogue output in mV.

2. The fiber optic signal transfer system for an optical fiber pay out test bed as defined in claim 1 wherein said optical fiber is about 250 μM diameter fiber and said LASER source transmits a 1300 Nm wavelength signal through said optical fiber, said 1300 Nm wavelength exiting said optical fiber received by said photodiode detector which converts said 1300 Nm wavelength signal to an analogue value of about 354.2 mV.

3. The fiber optic signal transfer system for an optical fiber pay out test bed as defined in claim 2 wherein said optical fiber supplied from a bobbin is transferred through a winding tension controller to maintain tension in the optical fiber, said winding tension controller supported by a level winding system which maintains level alignment of said optical fiber on said composite drum, said winding tension controller comprising a first upper pulley on the bobbin side of said system; a lower pulley which is a friction pulley which serves as a finer controller to maintain the tension in said optical fiber, said lower pulley functioning in said winding tension controller by movement up or down to maintain proper tension in said optical fiber which is wound on a second upper pulley; and, a second upper pulley for receiving said optical fiber having proper tension which is subsequently routed and wound on said composite drum.
